(19) United States
(12) Patent Application Publication
(10) Pub. No.: US 2008/0111737 A1
(43) Pub. Date: May 15, 2008

(54) METHOD AND SYSTEM FOR HYBRID LOCATION AIDING FOR MULTI-MODE DEVICES

(75) Inventors: Kristi A. Haverkamp, Chandler, AZ (US); Bobby D. Anderson, Gilbert, AZ (US); Brian E. Bucknor, Miramar, FL (US); Roberto Gautier, Davie, FL (US); Keith M. Klug, Mesa, AZ (US); Jose E. Korneluk, Lake Worth, FL (US); Charles H. Segerson, Tempe, AZ (US)

Correspondence Address: MOTOROLA, INC, 1303 EAST ALGONQUIN ROAD, IL01/3RD, SCHAUMBURG, IL, 60196, US

(73) Assignee: Motorola Inc., Schaumburg, IL (US)

(21) Appl. No.: 11/683,647

(22) Filed: Mar. 8, 2007

Related U.S. Application Data
(60) Provisional application No. 60/865,867, filed on Nov. 15, 2006.

(51) Int. Cl. G01S 5/14

(52) U.S. Cl. 342/357.09

(57) ABSTRACT

A method and system for location determination at a mobile communication device 102 is provided. The mobile communication device 102 includes a satellite positioning receiver 410. The mobile communication device 102 acquires a first location aiding parameter and a second location aiding parameter from a first Terrestrial Communication Network (TCN) 108 and a second TCN 110, respectively. Selection of the first TCN 108 and the second TCN 110 is based on the first and second location aiding parameters, respectively. The satellite positioning receiver 410 uses the first and second location aiding parameters to determine the location at the mobile communication device 102.

### CROSS-REFERENCE TO RELATED APPLICATION

The present application claims the benefit of U.S. Provisional Application Ser. No. 60/865,867, filed Nov. 15, 2006, which is hereby incorporated by reference herein.

### FIELD OF THE INVENTION

This invention relates in general to location aiding, and more particularly, to a method and system of location determination at a mobile communication device.

### BACKGROUND OF THE INVENTION

In today's world, the need for people to know the precise time is coupled with their desire to be aware of their exact location. The solution to this problem is location determination by using a location determining device. This location determining device is equipped with a satellite positioning receiver that determines its current location (longitude, latitude and altitude). The most popular satellite positioning receivers employ a Global Positioning System (GPS). GPS is a worldwide satellite navigation system formed by a constellation of 24 satellites orbiting the earth and is used for navigation on land, sea and air. The GPS is now indispensable for map-making and land surveying. Its accuracy is precise to a range of a few meters. The working of the GPS satellite positioning receiver is as follows: The satellite positioning receiver needs to establish a line-of-sight contact with at least four satellites in order to calculate location (latitude, longitude, altitude) and precise GPS time accurately. Acquisition of enough satellites to complete a calculation may take a minute to several minutes depending on signal conditions and even acquisition of satellite ephemeris directly from the satellites requires a minimum of 30 seconds. In such a situation, the receiver may utilize a Terrestrial Communication Network (TCN) to assist it in determining its location more quickly than would be possible in an unaided session. TCN aiding will reduce satellite acquisition time to a range between a few seconds to a minute in many cases because search ranges for parameters necessary to acquire the satellite signals can be significantly reduced. Examples of TCNs include, but are not limited to, iDEN networks, code division multiple access (CDMA) networks, wireless local area networks (WLANs), cellular data networks, GSM networks, wideband CDMA networks, and personal area networks. Location determination, with the help of a TCN, can be used in a mobile communication device that includes a satellite positioning receiver, to determine its location.

To enhance the process of location determination, an assistance server can be used with the TCN. Aided GPS (A-GPS) is a technology that utilizes an assistance server to reduce the time spent on location determination by using GPS. The assistance server acquires location aiding parameters from the TCN and communicates them to the satellite positioning receiver. This results in the satellite positioning receiver operating more quickly and effectively than when it is not assisted. The most important purpose of A-GPS is to provide emergency services such as the Enhanced 911 (E-911) service, the purpose of which is to trace the address of the caller and respond promptly to his/her request for assistance.

The satellite positioning receiver uses the location aiding parameters determined from the TCN to determine its location. Examples of the various location aiding parameters include, but are not limited to, a time of day aiding parameter, an approximate location aiding parameter, a frequency aiding parameter for correcting the frequency of a crystal oscillator and an ephemeris aiding parameter. Typically, the satellite positioning receiver monitors one main TCN at a time, and other TCNs are only monitored if the main TCN is not available. In one method for determining the location at the mobile communication device, the satellite positioning receiver estimates the location of the device aided by a TCN, and then estimates it again by using a counter method while roaming on another TCN. However, this approach does not enable the satellite positioning receiver to make the best choice among the aiding parameters of the two TCNs.

In another method for determining the location at the mobile communication device, the satellite positioning receiver connects to two TCNs simultaneously. However, the location at the mobile communication device is assumed to be the same as the location of one of the TCNs. Therefore, location determination by this approach is not precise to a few meters.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary environment in which various embodiments of the present invention can be practiced;

FIG. 2 illustrates a flow diagram of a method for determining the location at a mobile communication device, in accordance with an embodiment of the present invention;

FIG. 3 illustrates a flow diagram of a method for determining the location at a mobile communication device, in accordance with another embodiment of the present invention;

FIG. 4 illustrates a block diagram of the mobile communication device, in accordance with an embodiment of the present invention;

FIG. 5 illustrates a Time to First Fix (TTFF) graph with respect to the various qualities of a time of day aiding parameter, in accordance with an embodiment of the present invention;

FIG. 6 illustrates a TTFF graph with respect to the various qualities of an approximate location aiding parameter uncertainty for fully aided fixes at 23 Decibel-Hertz, in accordance with an embodiment of the present invention;

FIG. 7 illustrates a horizontal-position error graph with respect to the various qualities of the approximate location aiding parameter uncertainty for fully aided fixes at 23 Decibel-Hertz, in accordance with an embodiment of the present invention;

FIG. 8 illustrates an estimated-position error graph with respect to the various qualities of the approximate location aiding parameter uncertainty for fully aided fixes at 23 Decibel-Hertz, in accordance with an embodiment of the present invention; and

FIG. 9 illustrates a Dilution of Precision (DOP) graph with respect to the various qualities of the approximate location aiding parameter uncertainty for fully aided fixes at 23 Decibel-Hertz, in accordance with an embodiment of the present invention.

Skilled artisans will appreciate that elements in the figures have been illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for determining the location at a mobile communication device, in accordance with various embodiments of the present invention, it should be observed that the present invention resides primarily in combinations of method steps and apparatus components related to the method and system for determining the location at a mobile communication device. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, relational terms such as first and second, and the like, may be used solely to distinguish one entity or action from another entity or action, without necessarily requiring or implying any actual relationship or order between such entities or actions. The terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a”, does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

For an embodiment, a method for determining the location at a mobile communication device is described. The mobile communication device includes a satellite positioning receiver. The method also includes the mobile communication device acquiring a first location aiding parameter from a first Terrestrial Communication Network (TCN). Further, the method includes the mobile communication device acquiring a second location aiding parameter from a second TCN. The selection of the first TCN and second TCN is based on the first location aiding parameter and the second location aiding parameter, respectively. Furthermore, the method includes the satellite positioning receiver of the mobile communication device using the first location aiding parameter and the second location aiding parameter to determine the location at the mobile communication device.

For another embodiment, a mobile communication device for performing location determination is described. The mobile communication device includes a multi-mode transceiver and a processor. The multi-mode transceiver can simultaneously connect to a first Terrestrial Communication Network (TCN) and a second TCN. The selection of the first TCN and the second TCN is based on a first location aiding parameter and a second location aiding parameter, respectively. The processor includes a reception module and a satellite positioning receiver. The reception module can acquire the first location aiding parameter and the second location aiding parameter from the first TCN and the second TCN, respectively. The satellite positioning receiver can use the first location aiding parameter and the second location aiding parameter to determine the location at the mobile communication device.

In yet another embodiment, a system for performing location determination is provided. The system includes a first Terrestrial Communication Network (TCN) and a second TCN. The system also includes a mobile communication device, which is capable of connecting to the first TCN and the second TCN simultaneously. The mobile communication device can also acquire a first location aiding parameter and a second location aiding parameter from the first TCN and the second TCN, respectively.

Satellite navigation systems enable location determining devices to ascertain their accurate locations (longitude, latitude and altitude). The Global Positioning System (GPS) is a fully functional satellite navigation system formed by a constellation of 24 satellites orbiting the Earth. A satellite positioning receiver calculates its distance from a GPS satellite by measuring the time delay between the time the signals are transmitted from the GPS satellite and the time the signals are received at the satellite. The time delay thus obtained is then multiplied by the speed of light (equivalent to the speed of electromagnetic waves) to calculate the distance of the satellite positioning receiver from the GPS satellite.

The satellite positioning receiver determines the precise time by using search bins related to the known frequency accuracy of its internal crystal oscillator clock v/s satellite pseudorandom noise (PRN) sequence code bins. The satellite positioning receiver then determines the ephemeris data from each satellite on the line of sight when its search engine performs a correlation onto both the correct frequency and code bin simultaneously. The satellite positioning receiver needs to be on line of sight with at least four GPS satellites before it can calculate both location in three coordinates and GPS time accurately. The ephemeris data contains orbital information pertaining to the GPS satellite, which enables the satellite positioning receiver to calculate the position of the GPS satellite at any given point of time. This data is used to determine the precise location of the satellite positioning receiver.

The satellite positioning receiver may not be able to establish connection with four satellites at a given point of time as quickly as desired for user applications. In such an event, the satellite positioning receiver may require a Terrestrial Communication Network (TCN) to assist it to determine its location in a faster time period than could be achieved by operating independently. Examples of TCNs include, but are not limited to, iDEN networks, code division multiple access (CDMA) networks, wireless local area networks (WLANs), cellular data networks, GSM networks, wideband code division multiple access networks, and personal area networks. Location determination with the help of a TCN can be used to determine the location at a mobile communication device. The mobile communication device has the satellite positioning receiver to determine its location. However, to quickly and accurately calculate its location, the mobile communication device needs to determine various aiding parameters from the TCN. Examples of such parameters include, but are not limited to, a time of day aiding parameter, an approximate location aiding parameter, a frequency aiding parameter to correct the frequency of a crystal oscillator, and an ephemeris aiding parameter.

Aided GPS (A-GPS) is a technology that uses an assistance server with a TCN to reduce the time expended in location determination by using GPS. The assistance server accesses location aiding information from the TCN and communicates this information to the mobile communication device. Consequently, the mobile communication device can operate more quickly and effectively than it can without being assisted.

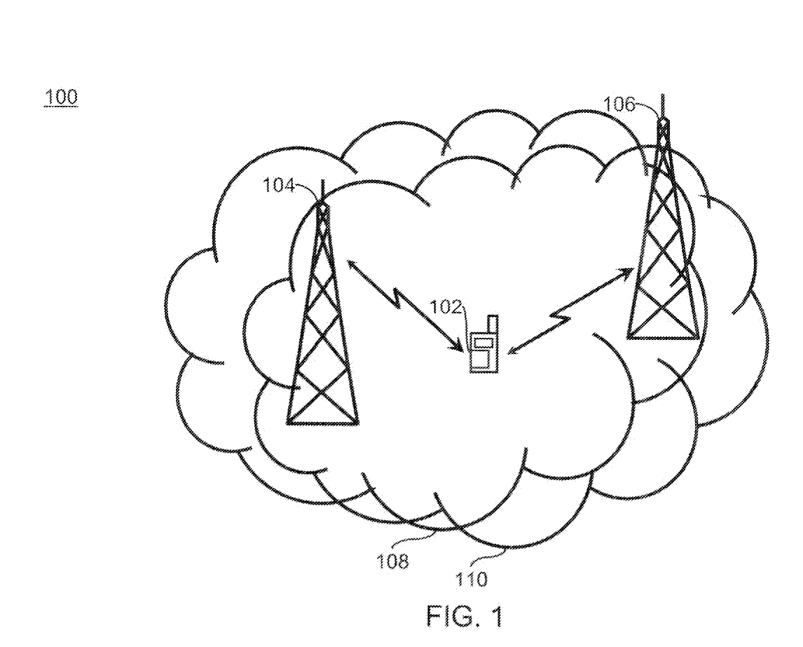

FIG. 1 illustrates an exemplary environment 100 in which various embodiments of the present invention can be practiced. A mobile communication device 102 is shown, which is connected to a Mobile Station (MS) 104 and an MS 106. The mobile communication device 102 is a multi-mode mobile communication device, which is able to operate simultaneously on more than one distinct TCN. The MS 104 and the MS 106 govern a first Terrestrial Communication Network (TCN) 108 and a second TCN 110, respectively. For example, the MS 104 governs an iDEN network, while the MS 106 governs a CDMA network. Hence, the mobile communication device 102 is connected to the iDEN network and the CDMA network simultaneously. It will be apparent to those skilled in the art that the mobile communication device 102 can also operate while being connected to one MS only. The mobile communication device 102 has been shown to be a dual-mode communication device for exemplary purposes only. Those skilled in the art will understand that the number of MSs connected to the mobile communication device 102 is not in any way limited to the MS 104 and the MS 106. The mobile communication device 102 connects to a third TCN if the connection to the TCNs 108-110 is lost.

To assist in quickly calculating its location, the mobile communication device 102 needs to determine the various aiding parameters of the TCNs 108-110. Examples of these parameters include, but are not limited to, a time of day aiding parameter, an approximate location aiding parameter, a frequency aiding parameter for correcting the frequency of a crystal oscillator, and an ephemeris aiding parameter.

The TCNs 108-110 synchronize the MS 104 and the MS 106, respectively, to GPS time by broadcasting and messaging. The GPS time is saved in the internal crystal oscillator clock and used as the time of day aiding parameter. The internal crystal oscillator clock creates an electric signal with a precise frequency, and is updated regularly by various GPS satellites. Apart from the time of day aiding parameter, the TCNs 108-110 also help in acquiring the approximate location aiding parameter. The TCNs 108-110 help the mobile communication device 102 on a location that is used as a starting point for location determination. The TCNs 108-110 may also aid the mobile communication device 102 to determine the searching range of GPS location determination around the starting point. Thus, the TCNs 108-110 provide the mobile communication device 102 with an approximate location aiding parameter.

The TCNs 108-110 also help the mobile communication device 102 by providing it with a higher accuracy reference frequency than is typically available in a handheld device. This reference frequency is utilized by the mobile communication device 102 to correct the frequency offsets of the internal crystal oscillator that cause it to vary from its ideal resonant frequency. The precise frequency of the internal crystal oscillator may be affected by environmental changes. Examples of such environmental changes include, but are not limited to, temperature, humidity, pressure, and vibration. Several oscillator designs reduce these environmental changes. These oscillator designs include, but are not limited to, Temperature Compensated Crystal Oscillator (TCXO), Microprocessor Compensated Crystal Oscillator (MCXO), and Oven Compensated Crystal Oscillator (OCXO). These oscillator designs reduce environmental effects on the precise frequency of the crystal oscillator. The TCNs 108-110 also help the mobile communication device 102 to acquire ephemeris data. This ephemeris data contains orbital information related to the GPS satellite, which enables the mobile communication device 102 to calculate the position of the GPS satellite at any given point of time.

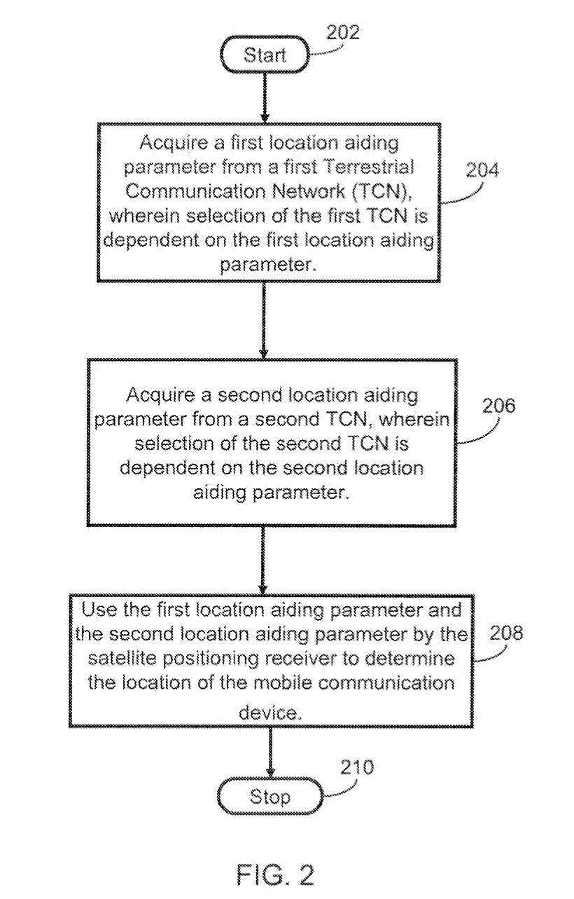

FIG. 2 illustrates a flow diagram of a method for determining the location of the mobile communication device 102, in accordance with an embodiment of the present invention. To describe the flow diagram, reference will be made to the elements described in conjunction with FIG. 1. It should be understood by a person ordinarily skilled in the art that the flow diagram can be implemented with reference to any other suitable embodiment of the present invention. The method is initiated at step 202. At step 204, a first location aiding parameter is determined from the first TCN 108. The selection of the first TCN 108 is dependent on the first location aiding parameter. For example, the mobile communication device 102 selects a CDMA network as the first TCN 108, since the CDMA network provides an accurate value for the time of day aiding parameter. Thereafter, the mobile communication device 102 acquires the time of day aiding parameter from the CDMA network. At step 206, a second location aiding parameter is determined from the second TCN 110. The selection of the second TCN 110 is dependent on the second location aiding parameter. For example, the iDEN network is selected as the second TCN 110 for acquiring the ephemeris aiding parameter. At step 208, the location of the mobile communication device 102 is determined by using the first and second aiding parameters. Therefore, according to the example provided above, the mobile communication device 102 will use the time of day aiding parameter and the ephemeris aiding parameter to determine its location. Thereafter, the process terminates at step 210.

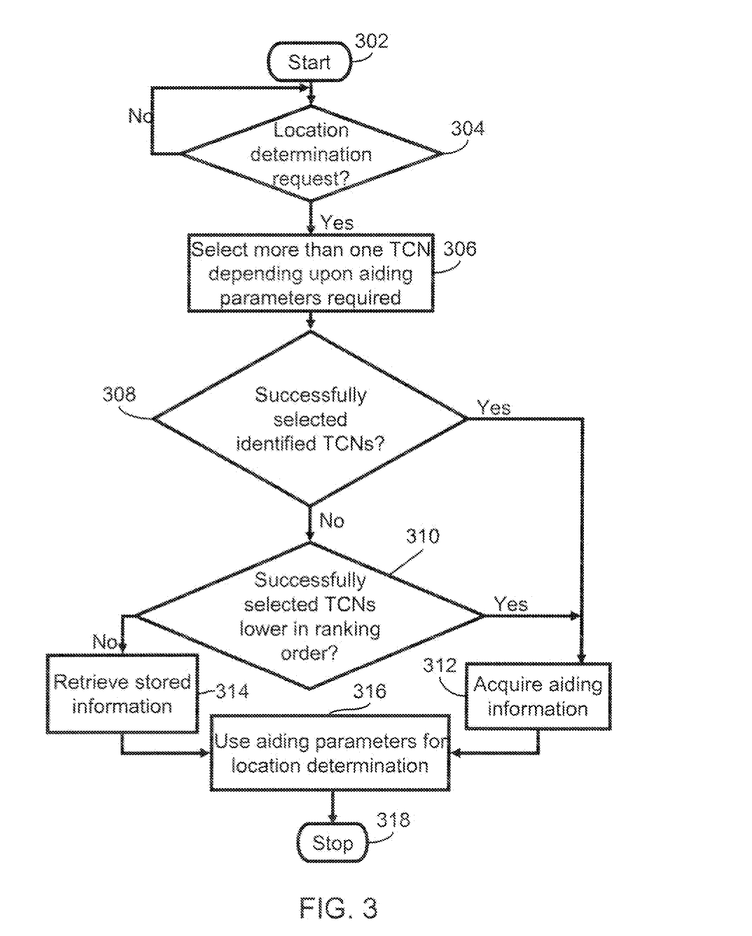

FIG. 3 illustrates a flow diagram of a method for determining the location at a mobile communication device 102, in accordance with another embodiment of the present invention. The method is initiated at step 302. At step 304, the mobile communication device 102 checks whether a location determination request has been made. If the location determination request has been made, the mobile communication device 102 checks a ranking order at step 306, to identify the TCNs it will try and select. A connection is established with more than one TCN, depending on the aiding parameters required. The ranking order of all the TCNs (the mobile communication device 102 has potential access to), with respect to various location aiding parameters, is maintained in the mobile communication device 102. This ranking order may be determined, based on a predefined ranking list. The predefined ranking list may be disposed of in the mobile communication device 102. Alternatively, the ranking order is determined by a ranking list that is maintained dynamically. In other words, the ranking list is updated after the values of the location aiding parameters of a particular TCN are obtained, for example, if the mobile communication device 102 needs to select two TCNs to obtain the approximate location aiding parameter and the time of day aiding parameter. The mobile communication device 102 checks the ranking order of the TCNs with respect to the two parameters mentioned above. The ranking order identifies a Local Area Network (LAN) as the best network to provide the approximate location aiding parameter, and the CDMA network as the best network to provide the time of day aiding parameter. The mobile communication device 102 tries to select the identified TCN.

At step 308, the mobile communication device 102 checks whether it has been successful in selecting the TCN it had identified at step 306. Continuing with the example provided, the mobile communication device 102 will try and simultaneously select the LAN and the CDMA network simultaneously. However, all the TCNs are not available worldwide. Further, at given points of time, certain TCNs have no bandwidth to accommodate additional mobile communication devices. Therefore, in such scenarios, the mobile communication device 102 is unable to select the identified TCNs. If the mobile communication device 102 determines that it has been successful in selecting the identified TCNs at step 308, the flow diagram continues at step 312. If, however, the mobile communication device 102 determines that it has been unsuccessful in selecting the identified TCNs, the flow diagram continues at step 310. Once the mobile communication device 102 has been unsuccessful at selecting the identified TCNs, it will try and select TCNs that are lower in the ranking order. At step 310, the mobile communication device 102 checks whether the TCNs that have a lower ranking order in the predefined ranking list of the location aiding parameters have been successfully selected. If the mobile communication device 102 determines at step 310 that it has been successful at selecting the TCNs with a lower ranking order, the flow diagram continues at step 312. If however, the mobile communication device 102 determines at step 310 that it has been unsuccessful at selecting the TCNs with a lower ranking order, the flow diagram continues at step 314.

At step 312, the mobile communication device 102 acquires the location aiding information from the selected TCNs. The selected TCNs may be either the identified TCNs or they may be the TCNs having a lower ranking order. At step 314, the stored location aiding parameters in the mobile communication device 102 are retrieved. At step 316, the location aiding parameters stored in the mobile communication device 102 are used to determine a location. Thereafter, the process terminates at step 318.

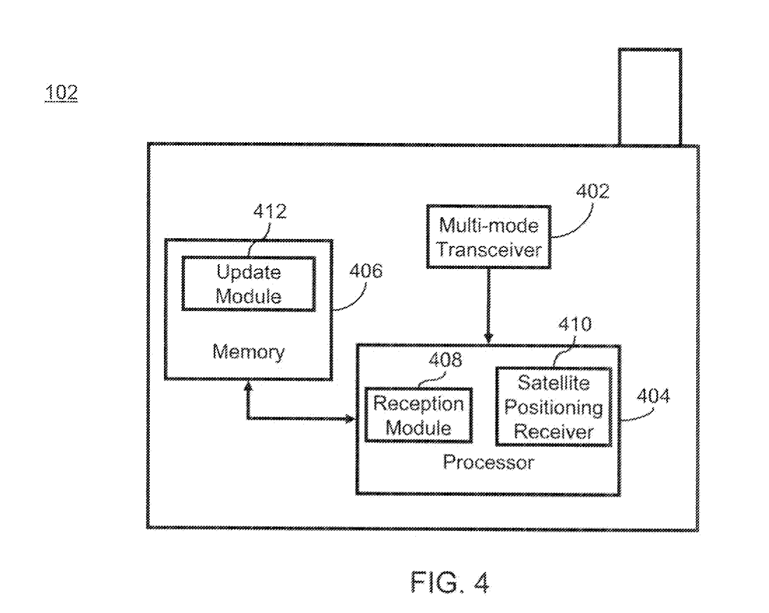

FIG. 4 illustrates a block diagram of the mobile communication device 102, in accordance with an embodiment of the present invention. The mobile communication device 102 includes a multi-mode transceiver 402, a processor 404, and a memory 406. The processor 404 includes a reception module 408 and a satellite positioning receiver 410. The memory 406 includes an update module 412. The multi-mode transceiver 402 connects the mobile communication device 102 to the TCNs 108-110 simultaneously. As mentioned earlier, the mobile communication device 102 is able to operate on more than one distinct TCN simultaneously. The multi-mode transceiver 402 communicates information pertaining to the TCN connections to the processor 404. The reception module 408 acquires the first and second location aiding parameters from the TCNs 108-110, respectively. The first and second location aiding parameters acquired by the reception module 408 are thereafter stored in the memory 406. The ranking order of the TCNs 108-110 is determined by the processor 404, based on the predefined ranking list disposed in the memory 406. If there is any change in the predefined rankling list, based on the ranking order of the TCNs 108-110, this change is incorporated in the memory 406 by the update module 412. Thereby, the ranking list is dynamically stored in the memory 406.

The satellite positioning receiver 410 uses the first and second location aiding parameters to determine the location at the mobile communication device 102. It will be apparent to those skilled in the art that the satellite positioning receiver 410 can use more than two location aiding parameters. It should also be understood by a person ordinarily skilled in the art that the satellite positioning receiver 410 can use only one or no location aiding parameter to determine its location. If the connection to either of the TCNs 108-110 is lost, the first and second location aiding parameters are acquired from a third TCN. Thereafter, the satellite positioning receiver 410 uses the location aiding parameters acquired from the third TCN, to determine the location at the mobile communication device 102. If the connection to all the TCNs is lost, the satellite positioning receiver 410 retrieves the best location aiding parameters from the memory 406, based on the predefined ranking list, to determine the location at the mobile communication device 102. Therefore, the mobile communication device 102 determines its location, based on the decision on selecting the best available time of day aiding parameter, approximate location aiding parameter, frequency aiding parameter, and ephemeris aiding parameter.

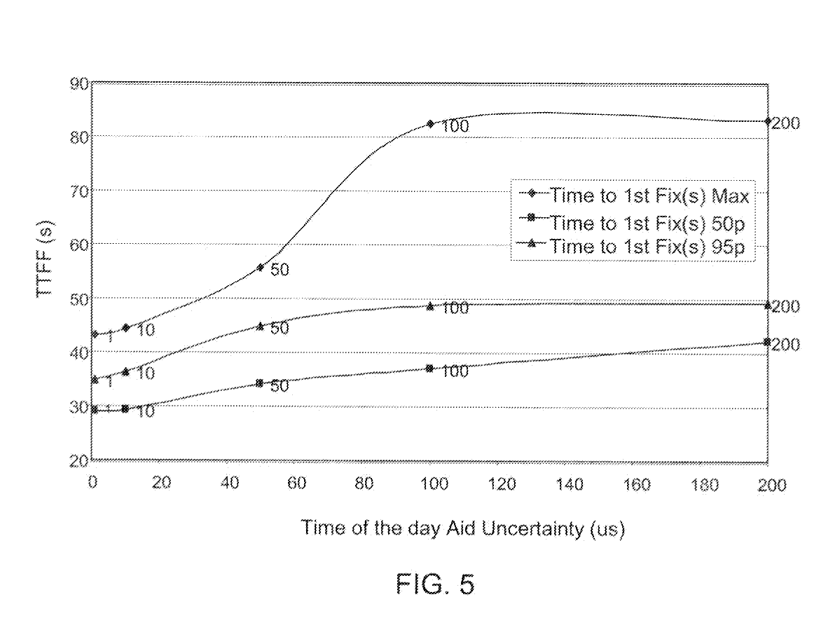

FIG. 5 illustrates a Time to First Fix (TTFF) graph with respect to the various qualities of a time of day aiding parameter uncertainty, in accordance with an embodiment of the present invention. The TTFF is represented on the y-axis, and the various qualities of a time of day aiding parameter uncertainty are represented on the x-axis. The TTFF comprises the time between turning on the satellite positioning receiver 410 to the time until the location at the mobile communication device 102 is determined. The graph clearly depicts that improvement can be made to the TTFF by various embodiments of the present invention. This improvement in the TTFF includes an improvement in the quality of the time of day aiding parameter. The graph depicts that 95 percent of TTFF improves by almost 15 seconds between a 100 micro second time of day aiding parameter uncertainty and a 10 micro second time of day aiding parameter uncertainty. Those with ordinary skill in the art will understand that the accuracy of time synchronization between a network and a mobile device achievable with highly synchronous network like CDMA may be expected to be of somewhat greater accuracy relative to a TDMA system where accuracy of synchronization is limited by its time slots or a GSM system which normally operates asynchronously.

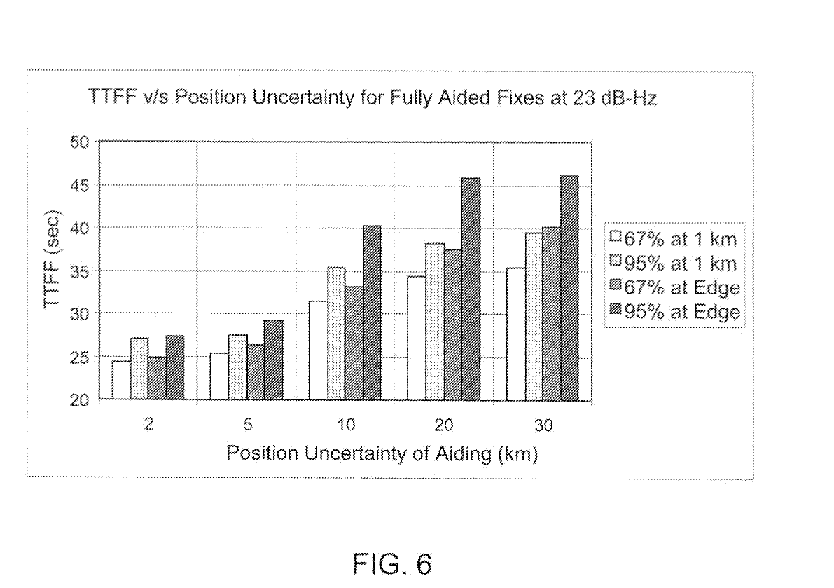

FIG. 6 illustrates a TTFF graph with respect to the various qualities of an approximate location aiding parameter uncertainty for fully aided fixes at 23 Decibel-Hertz, in accordance with an embodiment of the present invention. The TTFF is represented on the y-axis, and the various search range uncertainties (from 2-30 km) of an approximate location aiding parameter are represented on the x-axis. The search range uncertainty represents an assumed error range in the approximate location aid obtained from the TCN in +/−km in which the actual location of a user's mobile device may be found at the completion of its search. The starting seed aiding location is initially placed on the edge of the search range of the GPS location determination around the simulated user location. Then the starting point location aiding parameter is moved to be within one kilometer of the simulated user location for comparison. The graph depicts an improvement in the TTFF used in fix directly related to the quality of approximate location aiding parameters in various embodiments of the present invention. The TTFF used in fix is improved by better accuracy at the starting point of determining the location at the mobile communication device 102. For example, the improvement in the location aiding used in the fix can be achieved by an Advanced Forward-link Trilateration (AFLT) estimation of a CDMA or LAN approximation Both of those methods of obtaining location aid would be of greater accuracy v/s use of a wider search needed if the TCN location aid is merely the location of a wide area serving cell tower. The AFLT estimation may be carried out on the basis of the CDMA pilot phase measurements of the MS and neighbor stations the satellite positioning receiver 410 sent to TCN while requesting aid if the mobile device is able to monitor three or more cell towers at the time of the aiding request.

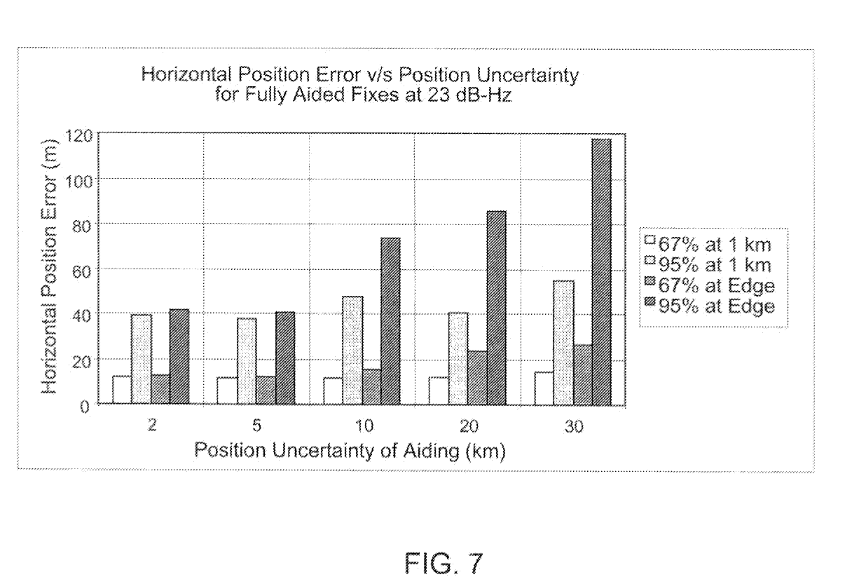

FIG. 7 illustrates a horizontal position error graph with respect to the various search range uncertainties in km of the approximate location aiding parameter for fully aided fixes at 23 Decibel-Hertz, in accordance with an embodiment of the present invention. The horizontal position error is represented on the y-axis and the various qualities of the approximate location aiding parameter uncertainty are represented on the x-axis. As in FIG. 6, a comparison is made between TCN approximate location aid being placed at the edge of the varying sizes of uncertainty search windows v/s a starting aid location that is within 1 km of the simulated user location. The graph depicts an improvement in the position accuracy used in the fix by achieving a better approximate location aiding parameter in various embodiments of the present invention. The position accuracy used in the fix is improved by the enhanced accuracy of the starting point of the location determination of the mobile communication device 102. As stated in the prior example, the improvement in the location aiding used in the fix can be achieved by an AFLT estimation of a CDMA or LAN approximation. Both of those methods of obtaining location aid would be of greater accuracy v/s use of a wider search needed if the TCN location aid is merely the location of a wide area serving cell tower.

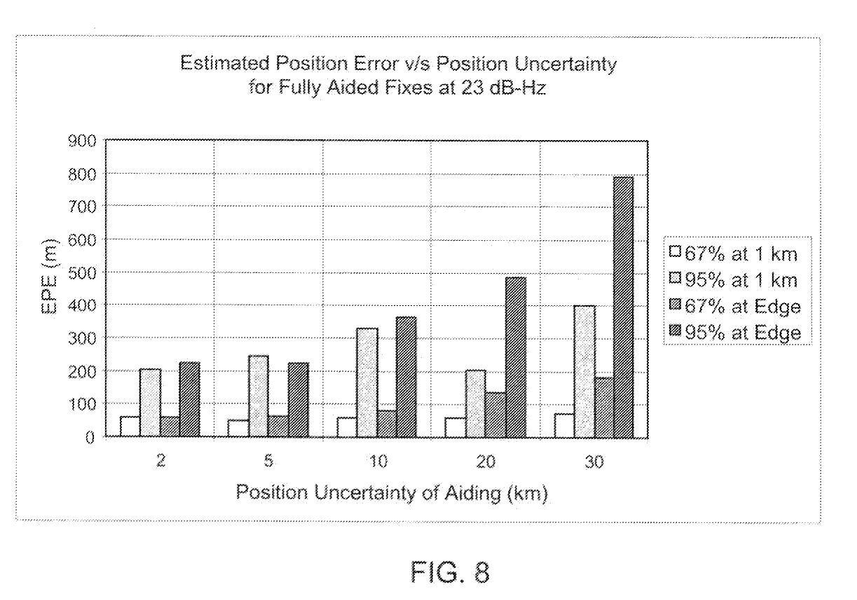

FIG. 8 illustrates an estimated position error graph with respect to the various search range uncertainties in km of the approximate location aiding parameter for fully aided fixes at 23 Decibel-Hertz, in accordance with an embodiment of the present invention. The estimated position error is represented on the y-axis and the various qualities of the approximate location aiding parameter uncertainty are represented on the x-axis. As in the prior examples, a comparison is made between TCN approximate location aid being placed at the edge of the varying sizes of uncertainty search windows v/s a starting aid location that is within 1 km of the simulated user location. The graph depicts an improvement in the estimated position error used in the fix by achieving an enhanced approximate location aiding parameter in various embodiments of the present invention. The estimated position error used in the fix is improved by the enhanced accuracy of the starting point of location determination at the mobile communication device 102. For example, the improvement in the location aiding used in the fix can be achieved by an AFLT estimation of CDMA or LAN approximation. Both of those methods of obtaining location aid would be of greater accuracy v/s use of a wider search needed if the TCN location aid is merely the location of a wide area serving cell tower.

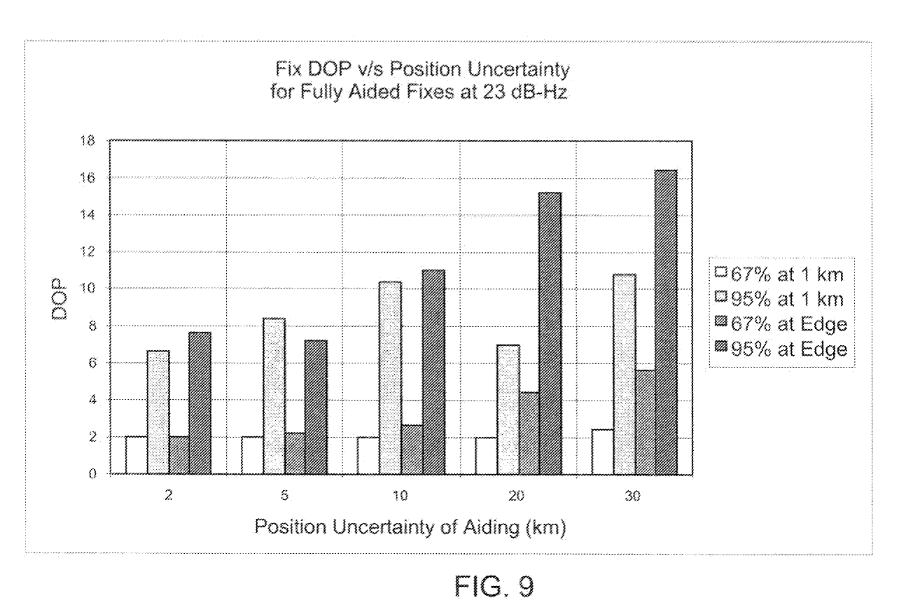

FIG. 9 illustrates a Dilution of Precision (DOP) graph with respect to the various search range uncertainties in km of the approximate location aiding parameter for fully aided fixes at 23 Decibel-Hertz, in accordance with an embodiment of the present invention. The DOP is represented on the y-axis and the various qualities of the approximate location aiding parameter uncertainty are represented on the x-axis. As in the prior examples, a comparison is made between TCN approximate location aid being placed at the edge of the varying sizes of uncertainty search windows v/s a starting aid location that is within 1 km of the simulated user location. The graph depicts an improvement in the DOP used in the fix by achieving an enhanced approximate location aiding parameter in various embodiments of the present invention. The DOP or geometry of the satellites used in the fix is improved by the enhanced accuracy of the starting point of location determination at the mobile communication device 102. Better satellite geometry in an initial satellite acquisition is known to those with skill in the art to have a direct correlation to the accuracy of the location calculation and the calculation of the estimated position error which were examined in FIGS. 7 and 8. The improvement in the location aiding used in the fix can be achieved by an AFLT estimation of a CDMA or LAN approximation. Both of those methods of obtaining location aid would be of greater accuracy v/s use of a wider search needed if the TCN location aid is merely the location of a wide area serving cell tower.

For an embodiment of the invention, a method and system for determining the location at the mobile communication device 102, based on a dual mode monitoring of the TCNs 108-110, is provided. Selection of the TCNs 108-110 is carried out, based on the first and second location aiding parameters. Location determination is performed by the satellite positioning receiver 410, based on the location aiding parameters determined from the identified TCNs 108-110. The ranking of the identified TCNs 108-110, with respect to the first and second location aiding parameters, is determined, based on the predefined ranking list disposed in the mobile communication device 102.

Some examples of a predefined ranking list are as follows: the time of day aiding parameter quality of the CDMA network can be assumed to be less than 10 microsecond, whereas the time of day aiding parameter quality of the iDEN network can be assumed to be of a lesser quality as a limitation of using assigned time slots for synchronization between TCN and a mobile device. Asynchronous systems such as GSM and WCDMA may also have a lesser time of day aiding parameter quality than the CDMA network due to difficulties in achieving precise time synchronization between TCN and mobile devices. Therefore, in the predefined ranking list, the time of day aiding parameter of the CDMA network can be rated as a first preference and the time of day aiding parameter of the iDEN network a second preference.

For approximate location aiding parameter, the CDMA network helps in locating the MS to be used as the starting point of location determination, based on the privacy requirements of the mobile communication device 102. If the mobile communication device 102 desires privacy, the location of the MS serves as the approximate location aiding parameter, with high uncertainty in the range of location determination. If user privacy is not desired, an AFLT estimation of the location by the satellite positioning receiver 410 may be returned as the approximate location aiding parameter if the mobile device is able to monitor pilot phases from three or more cell towers. The approximate location aiding parameter of the MS, from the iDEN network, is provided by broadcast. The range of location determination is determined by time advance. The time advance compensates for any propagation delay, since the speed of the electromagnetic waves is equivalent to the speed of light. In the predefined ranking list stored in the memory 406 for rating the approximate location aiding parameter, the CDMA's AFLT network can be rated as a first preference and the iDEN network's time advance can be rated as a second preference. The broadcasting of the MS location as the starting location from either the CDMA network or the iDEN network can be considered to be equivalent if CDMA AFLT is not available. Hence, use of serving cell location from either the CDMA network or the iDEN network can be rated higher as a third preference. Equivalent frequency aid and ephemeris aid can be most accurately selected from any of the identified TCNs 108-110.

The ephemeris expires over a time frame of a couple of hours; therefore current ephemeris aid from the identified TCNs 108-110 is better than the ephemeris aid obtained from the predefined ranking list stored in the memory 406. The TCXO frequency aiding parameter is more accurate when the mobile communication device 102 is connected to the identified TCNs 108-110. A frequency error can be calculated from the known frequencies of the identified TCNs 108-110. The TCXO frequency aiding parameter is not broadcasted by any TCN, unlike the time of day aiding parameter, the approximate location aiding parameter and the ephemeris aiding parameter. One method for acquiring a TCXO frequency aiding parameter from the identified TCNs 108-110 is to directly lock the GPS crystal oscillator clock to an accurate reference frequency derived from the TCN. Another method may involve calculating the difference between a free running TCXO and the TCN reference frequency thereby providing an estimate of the TCXO frequency offset value that can be used by the search engine.

Due to some unavoidable reasons such as Doppler shifts between the mobile communication device 102 and the identified TCNs 108-110, there can be errors in calculating the accurate offset frequency of the TCXO frequency aiding parameter. The tolerance range of the errors is generally stated in Parts per Million (PPM) relative to the operating frequency Fₒ of the oscillator. The assumed error is used as a search window in +/−PPM around the estimated Fₒ of the device. This search window is broken into small frequency bins that are used to precisely correlate against known satellite PRN codes when acquiring satellites. A device operating in conjunction with a TCN is often able to reduce the search range needed to determine the precise TCXO Fₒ to less than +/−1 PPM around the estimated Fₒ derived by using the TCN reference frequency. A device operating without the benefit of a TCN for estimation of its oscillator's current Fₒ might need to use a search range of +/−6 PPM or greater (depending on thermal tolerances of the part and other environmental factors) to determine the precise Fₒ value necessary for satellite acquisition. Those with ordinary skill in the art will understand that a wider search window for any aiding parameter will produce a greater number of search bins to evaluate which has a direct effect on the length of time needed to acquire satellite signals and complete a location calculation. It is also understood that if access to one TCN is lost in a multi-mode device, obtaining frequency aid by virtue of connection to an alternate TCN would be preferable to using a wide off-network frequency aid value thereby creating an opportunity for preference ranking of the frequency aid.

The location aiding parameters could also be obtained from a third TCN if the identified TCNs 108-110 are not present. The third TCN is lower in ranking order than the identified TCNs 108-110. For example, if the connection to the CDMA network and the iDEN network is lost while determining the time of day aiding parameter, third best aiding from the available TCNs is assumed to be the time of day aiding parameter. The ranking list stored in the memory 406 is updated by the update module 412 in such a case, with the inclusion of the location aiding parameter from the third TCN. Thereby, the ranking list is dynamically maintained in the memory 406. If the connection to the identified TCNs 108-110 is lost, and the third TCN is also not available, the location aiding parameters are determined from the predefined ranking stored in the memory 406. For example, if the connection to all the TCNs is lost while determining the time of day aiding parameter, the time of day aiding parameter is determined from the predefined ranking stored in the memory 406.

For another embodiment, there is more than one satellite positioning receiver and the location aiding parameters are determined from all the satellite positioning receivers. There are two satellite positioning receivers. The CDMA network is the primary network and data path for a first satellite positioning receiver and the iDEN network is a primary network and data path for a second satellite positioning receiver. The first satellite positioning receiver is primary for E-911 and the second satellite positioning receiver is preferred over the first satellite positioning receiver for some applications. However, in light of the present invention, the second satellite positioning receiver can also monitor the CDMA network. The time of day aiding parameter is obtained from the CDMA network so that the TTFF s faster for the second satellite positioning receiver. The approximate location aiding parameter and frequency aiding parameters can be obtained from the iDEN network. Following the data optimization approach to improve acquisition sensitivity, the ephemeris aiding parameter will not be requested from the identified TCNs. If the ephemeris aiding parameter is also desired, it could be acquired from the CDMA network. Further, to improve the quality of the approximate location aiding parameter, it can be obtained from the CDMA network.

If the iDEN network is not monitored in a scenario, the second satellite positioning receiver is still primary for some applications. The second satellite positioning receiver can acquire all the location aiding parameters from the CDMA network. Conversely, if the iDEN network is the primary network for the first satellite positioning receiver, the first satellite positioning receiver is preferred over the second satellite positioning receiver. In this case, the time of day aiding parameter and the frequency aiding parameter could still be from the CDMA network. The approximate location aiding parameter could be acquired from either the CDMA network or the iDEN network, whereas the ephemeris aiding parameter could primarily be acquired from the iDEN network. If the connection to the CDMA network is lost, the first satellite positioning receiver could still acquire all the location aiding parameters from the iDEN network.

In yet another embodiment, a method and system for determining the location of the mobile communication device 102, based on multi-mode monitoring of the identified TCNs and a LAN, is provided. The LAN includes, but is not limited to, wide local area networks and Bluetooth. The quality of the approximate location aiding parameter improves significantly by monitoring the LAN and the identified TCNs simultaneously. The time of day aiding parameter, the frequency aiding parameter and the ephemeris aiding parameter would preferably still be acquired from the identified TCNs, as described in the above mentioned embodiments. The approximate location iding parameter acquired from the LAN is rated as the first preference in the predefined ranking list stored in the memory 406. However, if both the identified TCNs and the LAN are not available, the location aiding parameters would be acquired from the memory 406.

Various embodiments, as described above, provide a method and system for location determination at the mobile communication device 102. By monitoring more than one TCN simultaneously, a decision is taken about selecting the location aiding parameters from the more than one TCN, based on the ranking list stored in the memory 406. By this method, a faster TTFF and more accurate starting point estimation than earlier methods is reported. There is also a noticeable improvement in the estimated position error and the DOP with help of more accurate starting point estimated.

It will be appreciated that the method and system for location determination at the mobile communication device 102, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. As such, these functions may be interpreted as steps of a method to enable location determination at a mobile communication device differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method of performing a location determination at a mobile communication device, the mobile communication device having a satellite positioning receiver, the method comprising:
acquiring a first location aiding parameter from a first terrestrial communication network, wherein selection of the first terrestrial communication network is dependent on the first location aiding parameter;
acquiring a second location aiding parameter from a second terrestrial communication network, wherein selection of the second terrestrial communication network is dependent on the second location aiding parameter; and
using the first location aiding parameter and the second location aiding parameter by the satellite positioning receiver to determine the location at the mobile communication device;
wherein the mobile communication device is simultaneously connected to the first terrestrial communication network and the second terrestrial communication network while acquiring the first and second location aiding parameters.

2. The method according to claim 1, wherein the first and second terrestrial communication networks are selected from among an iDEN network, a code division multiple access network, a wireless local area network, a cellular data network, a GSM network, a wideband code division multiple access network and a personal area network.

3. The method according to claim 1, wherein either the first or second location aiding parameter is a time of day aiding parameter.

4. The method according to claim 1, wherein either the first or second location aiding parameter is an approximate location aiding parameter.

5. The method according to claim 1, wherein either the first or second location aiding parameter is a frequency aiding parameter for correcting the frequency of a temperature compensated crystal oscillator disposed in the mobile communication device.

6. The method according to claim 1, wherein either the first or second location aiding parameter is an ephemeris aiding parameter.

7. The method according to claim 1, wherein acquiring the first and second location aiding parameters comprises determining a ranking of the first and second terrestrial communication networks with respect to the first and second location aiding parameters.

8. The method according to claim 7, wherein determining the ranking is performed using a predefined ranking list of terrestrial communication networks, the predefined ranking list being disposed within the mobile communication device.

9. The method according to claim 7 further comprising dynamically maintaining the ranking list.

10. The method according to claim 7 further comprising acquiring either the first or second location aiding parameter from a third terrestrial communication network having a position lower in rank then the first and second terrestrial communication networks when a connection with either the first or second terrestrial communication network is lost.

11. The method according to claim 1 further comprising storing the first and second location aiding parameters in a memory of the mobile communication device.

12. The method according to claim 11 further comprising upon performing a subsequent location determination, when connection to either the first or second terrestrial communication networks is lost, acquiring the first or second location aiding parameter from the memory of the mobile communication device.

13. A mobile communication device for performing location determination, the mobile communication device comprising:
a multi-mode transceiver, the multi-mode transceiver being capable of connecting to a first terrestrial communication network and a second terrestrial communication network simultaneously, wherein selection of the first and second terrestrial communication networks is dependent on a first location aiding parameter and a second location aiding parameter;
a processor, the processor comprising:
a reception module, the reception module being capable of acquiring the first and second location aiding parameters from the first and second terrestrial communication networks; and
a satellite positioning receiver, the satellite positioning receiver being capable of using the first and second location aiding parameters to determine location of the mobile communication device.

14. The mobile communication device as recited in claim 13 further comprising a memory, the memory being capable of storing the first and second location aiding parameters.

15. The mobile communication device as recited in claim 14, wherein the memory stores a ranking list, the ranking list comprises a ranking order of the first and second terrestrial communication networks for the first and second location aiding parameters.

16. The mobile communication device as recited in claim 15, wherein the memory further comprises an update module, the update module being capable of dynamically maintaining the ranking list.

17. A system of performing location determination, the system comprising:
a first terrestrial communication network;
a second terrestrial communication network; and
a mobile communication device, the mobile communication device being capable of connecting to the first and second terrestrial communication networks simultaneously and acquiring a first location aiding parameter and a second location aiding parameter from the first and second terrestrial communication networks.

18. The system as recited in claim 17, wherein the first and second terrestrial communication networks are selected from among an iDEN network, a code division multiple access network, a wireless local area network, a cellular data network, a GSM network, a wideband code division multiple access network and a personal area network.

19. The system as recited in claim 17, wherein the mobile communication device further comprises a memory to store a ranking list, the ranking list comprises a ranking order of the first and second terrestrial communication networks for the first and second location aiding parameters.
